(19) United States
(12) Patent Application Publication
(10) Pub. No.: US 2005/0237703 A1
(43) Pub. Date: Oct. 27, 2005

(54) Mobile telephone handset with multipositional screen

(75) Inventor: Anders Angelhag, Lund (SE)

Correspondence Address: JENKENS & GILCHRIST, PC, 1445 ROSS AVENUE, SUITE 3200, DALLAS, TX, 75202, US

(73) Assignee: Sony Ericsson Mobile Communications AB, Lund (SE)

(21) Appl. No.: 10/828,880

(22) Filed: Apr. 21, 2004

(51) Int. Cl. G06F 1/16

(52) U.S. Cl. 361/683

(57) ABSTRACT

A communication device operates in first and second modes, such as a gaming mode and a communication mode. The communication device includes a communication device body adapted for a first mode of operation, a display screen disposed in generally parallel relationship with the device body in the first mode of operation, and a pivoting means disposed between the display screen and the device body for permitting the display screen to pivot into a position generally orthogonal to the device body for the second mode of operation. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims. 37 CFR 1.72(b).

### TECHNICAL FIELD

The present invention relates to mobile telephone handsets, and more particularly, but not by way of limitation, to a mobile telephone handset having a display screen positionable in at least two positions for facilitating first and second modes of operation.

### BACKGROUND OF THE INVENTION

Handheld mobile telephones have grown in popularity throughout the world. This widespread acceptance has resulted in mobile telephones becoming a common part of both modern society and contemporary business. There are many reasons for the success of mobile telephones and they include the inherent ease of with which a user can access telephonic communication from place to place without the concern of fixed communication networks. This ease in communication access allows greater convenience for the consumer and increased efficiency for businesses.

Along with the growth in popularity of mobile telephones has been the increasing popularity of devices such as text messaging systems and portable game consoles. These communication and entertainment units are often used by the same individuals who carry and use mobile telephones. The entertainment units, for example allow the user to enjoy popular arcade games, puzzles, competition with other game console users while the messaging devices allow emailing and text messaging capabilities. Portable gaming and messaging have thus joined the popularity of mobile telephones in becoming major commercial market items. With a mobile telephone, the user can stay in touch with others and with the mobile gaming console, messaging applications, etc., the user can find multiple ways to be entertained.

It is well known that modern mobile telephones, which are commercially acceptable to the larger market, are typically small in size. This is because it is common to carry handheld mobile telephones in pockets, on belts, in purses and briefcases. With the smaller size of the mobile telephone, use of the mobile telephone as a gaming console or messaging device can be limited. In order to provide a gaming or messaging application, a mobile telephone screen must be sufficiently large to allow the user to fully enjoy a display of, for example, a car race, intricate puzzle, or email screen. For this reason, various designs have attempted to maximize the efficiency of the mobile telephone, while at the same time, providing an application for the user to have excellent control for gaming and messaging applications.

In light of the above, mobile telephone manufacturers have addressed the issue by combining the two applications. For example, consumers interested in both phone-based applications and gaming applications may use the new SONY ERICSSON attachable game pad for the Z600 Flip Phone, which is denominated the EGB-10. This attachable game pad is but one example of a device that provides the ability to utilize the inherent features of a mobile telephone handset in an active gaming entertainment.

Other mobile telephone manufacturers have also incorporated mobile gaming functionality aspect into the mobile telephone itself. There is, for example, the NOKIA N-Gage mobile telephone, which includes an all-in-one entertainment and communication device. This particular unit is a hybrid of a conventional mobile telephone, a game console, a music player and a web surfer. The N-Gage includes large buttons that are positioned for ease in using the unit as a gaming console.

The SO505I and S700 mobile telephones manufactured by Sony Ericsson also allow both a gaming functionality and a communication functionality. Both the SO505I and the S700 include a swivel screen that pivots along a top portion of the mobile telephone. Various buttons are located on one side of the display screen and underneath the display screen.

It is an established trend in the mobile telephone market, as referenced above, to provide mobile handsets that are relatively small. It has been reported that the average consumer appears to be drawn to smaller telephones each year. Although gaming applications can be enjoyable, the enlargement of the mobile telephone handset itself in order to include other applications, could be seen as contrary to certain market trends. The same holds true for the gaming accessories, which may be as big as the mobile telephone itself. In some cases, the accessories are larger than the mobile telephone itself. Obviously, the accessory must be brought everywhere the mobile telephone is brought if the accessory is to be used for the full gaming experience. This situation is not always convenient.

### SUMMARY OF THE INVENTION

The present invention relates to mobile telephone handsets that may be used for various applications. More particularly, the communication device of an embodiment of the present invention includes a communication device body adapted for a first mode of operation, a display screen disposed in generally-parallel relationship with the device body in the first mode of operation, and a pivoting means disposed between the display screen and the device body for permitting the display screen to pivot into a position generally orthogonal to the device body for the second mode of operation.

In another aspect, the present invention relates to a method of operating a communication device in both first and second modes of operation. The method comprises the steps of rotating a pivotal upper portion into a second position for a second mode, actuating specific keys for receiving user input, and rotating the pivotal upper portion into a first position for a first mode to end the second mode.

In another aspect, the present invention relates to a communication device including a communication device body in a first position adapted for a first mode of operation, a display screen disposed in a generally parallel relationship with the device body in the first mode of operation, and pivoting means disposed between the display screen and the device body for permitting the display screen to pivot into a second position for a second mode of operation. In the first mode of operation, keys of the communication device are located on one side of the display screen and in the second mode of operation, keys of the communication device are located on at least two sides of the display screen.

In another aspect, the present invention relates to a communication device including a communication device body in a first position adapted for a first mode of operation, a display screen disposed in a generally parallel relationship with the device body in the first mode of operation, and pivoting means disposed between the display screen and the device body for permitting the display screen to pivot into a second position for a second mode of operation. In the first mode of operation, the communication device is operable by one hand of a user and in the second mode of operation, the communication device is operable by two hands of a user.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a top plan view of a mobile telephone handset with multipositional screen constructed in accordance with one aspect of the present invention;

FIG. 2 is a side elevational diagrammatic schematic of the mobile telephone handset of FIG. 1, illustrating one diagrammatic embodiment of a pivotal relationship between the display screen and the body of the mobile telephone handset;

FIG. 3 is a top plan view of the mobile telephone handset with the multipositional screen of FIG. 1 illustrating the multipositional screen pivoting into a second mode position;

FIG. 4 top plan view of the mobile telephone handset with the multipositional screen of FIG. 1 with the multipositional screen pivoting to the second mode position;

FIG. 5 is a top plan view of the mobile telephone handset with the multipositional screen pivoted into the second mode and illustrating the application of the second mode presented on the multipositional screen; and

FIG. 6 is a flow diagram illustrating a method of an embodiment of the present invention.

### DETAILED DESCRIPTION

Consumers interested in both phone based applications and other applications such as gaming and messaging will, by using various embodiments of the present invention, be able to mix the various applications in a mobile telephone handset capable of handling the applications effectively. This aspect has been provided by the pivotal mounting of the mobile telephone handset display screen relative to the body of the mobile telephone handset. When the display screen is pivoted into a generally orthogonal position relative to the mobile telephone handset, other features of the mobile telephone handset (e.g., gaming, messaging, etc.) may be accessed. Although only gaming and messaging are specifically mentioned herein as other features of the mobile telephone handset, additional features, applications and the like are also included. For example, it will be understood by one skilled in the art that various applications other than gaming, such as video or audio applications, may be accessed in the second mode It will also be understood by one skilled in the art that at least some applications may be accessed without pivoting the display screen into an angled position.

Referring first to FIG. 1, there is shown a mobile telephone handset 100 having a display screen 102. The mobile telephone handset 100 further includes a handset body portion 104 having a lower region 106 including a key array 108. The key array 108 can further include some additional indicia 110 specifically adapted for a second application such as gaming. Although the illustrated embodiment illustrates the additional indicia 110 as a series of symbols, any indicia may be utilized, such as, for example, colors or other symbols or images.

Still referring to FIG. 1, the mobile telephone handset 100 is constructed with a pivotal upper portion 120 comprising both the display screen 102 and a plurality of control buttons 122 that may or may not be adapted for actuation in a second mode. The control buttons 122 may also be actuated in a first mode. In another embodiment, there may be no control buttons 122 located on the pivotal upper portion 120. As described below, the pivotal actuation of the pivotal upper portion 120 is afforded by a pivot, hinge, or sliding track 124 allowing the mobile telephone handset 100 to be put into a locked second-mode position as described below. Although the pivot, hinge, or sliding track 124 is visible in this embodiment, it is within the scope of the present invention to provide a pivot, hinge, or sliding track 124 that is not visible to the user. The sliding track 124 may function as a protrusion that slides in the track to pivot the upper portion 120.

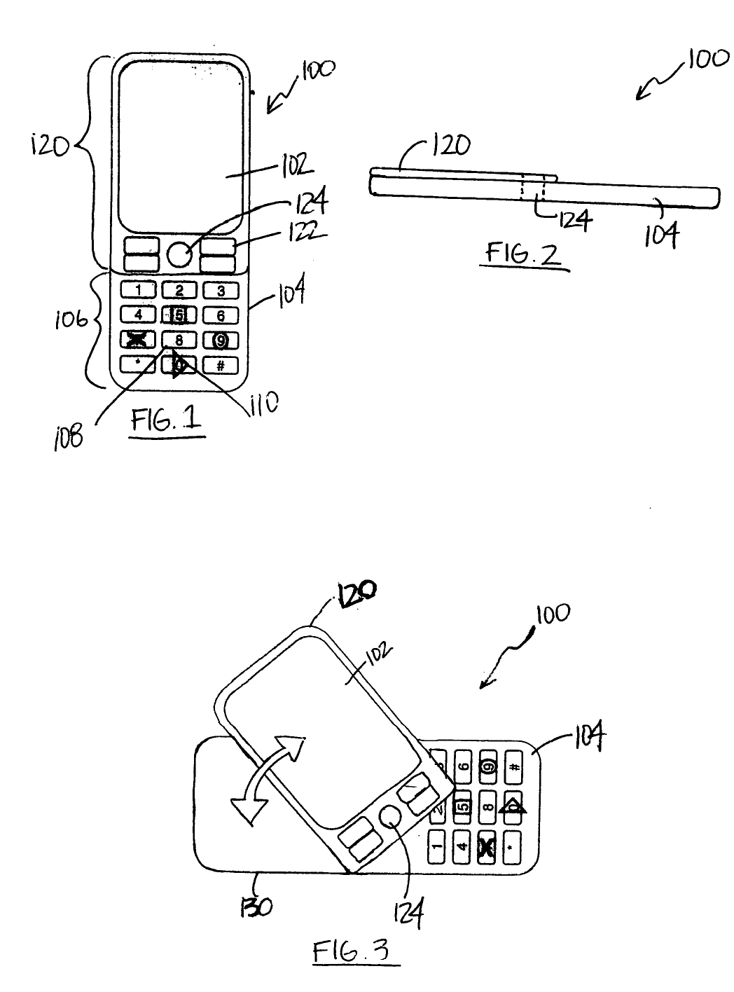

Referring now to FIG. 2, there is shown a side elevational diagrammatic schematic of the mobile telephone handset 100 of FIG. 1 illustrating one diagrammatic embodiment of a pivotal relationship between the pivotal upper portion 120 and the handset body portion 104 of the mobile telephone handset 100. It may be seen that the pivot or hinge 124 is disposed between the pivotal upper portion 120 of the mobile telephone handset 100 allowing the display screen 102 to pivot outwardly therefrom. The pivot 124 may comprise a simple mechanical structure interconnecting the display screen 102 of the pivotal upper portion 120 to the handset body portion 104 of the mobile telephone handset 100. The prior art is replete with pivotal mechanisms and additional detail relative to the size, shape and/or other configurational aspects of the pivot or hinge 124 is not deemed necessary.

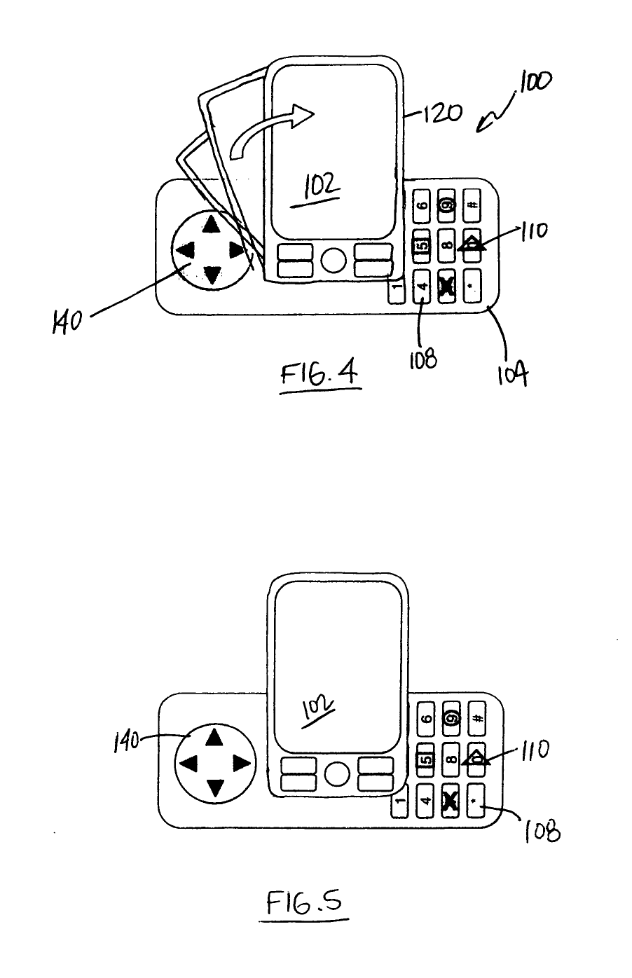

Referring now to FIG. 3, there is shown the mobile telephone handset 100 of FIG. 1 with the display screen 102 pivoting outwardly from an upper telephone base section 130 disposed beneath the display screen 102 in the closed mode shown in FIG. 1. The upper telephone base section 130 may include some additional features that are exposed by the pivotal movement of the pivotal upper portion 120 relative to the upper telephone base section 130.

Referring now to FIG. 4, there is shown the mobile telephone handset 100 of FIG. 1 in the second mode. In the second mode, the display screen 102 is positioned generally orthogonally to the handset body portion 104, whereby the pivotal upper portion 120 covers select ones of the key array 108 but exposes a pad 140 specifically adapted for the second mode function of the mobile telephone handset 100. Although in the illustrated embodiment various keys may be covered by the display screen 102 in the second mode, in other embodiments, no keys of the key array 108 may be covered by the display screen 102. The pad 140 may be any type of instrument that receives information from a user. For example, the pad 140 may be a directional arrow pad, a type of joystick, and/or one or more buttons.

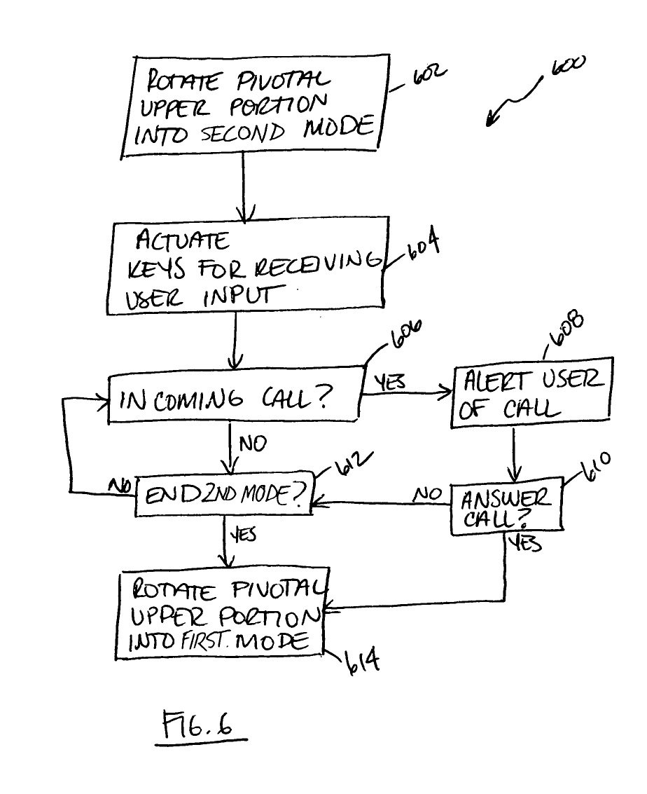

Referring now to FIG. 5, there is shown the mobile telephone handset 100 of FIG. 1 in the second mode with a functionality available on the display screen 102. It may be seen that the pad 140 and select keys as marked by the additional indicia 110 are readily available for the functionality.

Referring now to FIG. 6, there is shown a flow diagram of an embodiment of the present invention. A method 600 begins at step 602 when a user rotates the pivotal upper portion 120 of the mobile telephone handset 100 into the second mode. At step 604, the keys used in the second mode are actuated for receiving user inputs. The keys may be, for example, a pad 140 and/or any keys in the key array 108. The keys in the key array 108 that may be used for the second mode may have additional indicia. The user, at this point, may then actuate a function of the second mode (e.g., play a game or actuate any of the gaming functions or other applications). At step 606, it is determined whether there is an incoming call while the mobile telephone handset 100 is in the second mode. If there is an incoming call, then at step 608, the user is alerted of the call. The user may be alerted via any audio, visual, or tactile alert. In addition, the application of the second mode (games or other applications) in use by the mobile telephone handset 100 may be paused and/or the keys utilized in the second mode may be disengaged. At step 610, the user determines whether to answer the incoming call. If the user does not desire to answer the call, then at step 612, the user is returned to the application of the second mode that was in use. The application of the second mode may be unpaused, restarted, or ended as the user sees fit. If the user does decide to answer the call at step 610, or end the application of the second mode at step 612, then at step 614, the pivotal upper portion is rotated into a first mode. In addition, at step 610, the user may wish to answer the call and continue the application of the second mode. In this case, the pivotal upper portion may remain in the second mode.

It is thus believed that the principles of the present invention will be apparent from the foregoing Detailed Description. While various devices are shown and described, it will be obvious to a person of ordinary skill in the art that various changes and modifications may be made therein without departing from the spirit and scope of the invention, as defined in the following claims. Therefore, the spirit and the scope of the appended claims should not be limited to the Detailed Description.

1. A communication device comprising:
a communication device body adapted for a first mode of operation;
a display screen disposed in a generally parallel relationship with the device body in said first mode of operation; and
pivoting means disposed between said display screen and said device body for permitting said display screen to pivot into a position generally orthogonal to said device body for a second mode of operation.

2. The device of claim 1, wherein said second mode of operation comprises gaming and said device further comprises a gaming pad disposed on the communication device body and beneath the display screen.

3. The device of claim 2, wherein the gaming pad is hidden when the communication device is in the first mode of operation and the gaming pad is visible when the communication device is in the second mode of operation.

4. The device of claim 2, wherein the gaming pad is actuated during the second mode of operation.

5. The device of claim 2, wherein the gaming pad comprises directional arrows.

6. The device of claim 2, wherein the gaming pad comprises a plurality of buttons.

7. The device of claim 6, wherein at least one of the plurality of buttons is a pause button.

8. The device of claim 2, wherein the gaming pad comprises a joystick.

9. The device of claim 1, wherein the pivoting means comprises a hinge.

10. The device of claim 1, further comprising a key array, the key array including a plurality of keys.

11. The device of claim 10, wherein at least one of the plurality of keys is actuated during the second mode of operation.

12. The device of claim 11, wherein the at least one of the plurality of keys actuated during the second mode of operation includes an additional indicia.

13. The device of claim 1, wherein the pivoting means is oriented as a protrusion for sliding in a track.

14. A method of operating a communication device in a first mode and a second mode, the method comprising the steps of:
rotating a pivotal upper portion of the communication device into the second mode;
actuating specific keys of the communication device for receiving user input; and
rotating the pivotal upper portion into the first mode to end the second mode.

15. The method of claim 14 wherein the first mode of operation is telecommunication and the method further comprises the steps of:
determining whether the communication device is receiving an incoming call; and
alerting a user of the incoming call.

16. The method of claim 15, wherein the step of alerting the user comprises the steps of:
alerting the user via at least one of an audio, visual, and tactile alert; and
pausing the second mode.

17. The method of claim 16, wherein if the user determines not to answer the incoming call, then the second mode is unpaused.

18. The method of claim 14, further comprising the step of answering the incoming call by rotating the pivotal upper portion into the first mode.

19. The method of claim 14, wherein the step of actuating specific keys comprises the steps of:
actuating a gaming pad; and
actuating at least one key in a key array.

20. The method of claim 14, further comprising the step of actuating a second mode application by rotating the pivotal upper portion of the communication device.

21. The method of claim 14, wherein the second mode is a gaming mode.

22. The method of claim 14, wherein the second mode is a messaging mode.

23. A communication device comprising:
a communication device body in a first position adapted for a first mode of operation;
a display screen disposed in a generally parallel relationship with the device body in said first mode of operation;
pivoting means disposed between said display screen and said device body for permitting said display screen to pivot into a second position for a second mode of operation; and
wherein in the first mode of operation, keys of the communication device are located on one side of the display screen and in the second mode of operation, keys of the communication device are located on at least two sides of the display screen.

24. The communication device of claim 23, wherein the first mode is a communication mode.

25. The communication device of claim 23, wherein the second mode is a gaming mode.

26. The communication device of claim 23, wherein the second mode is a messaging mode.

27. The communication device of claim 23, further comprising a gaming pad disposed on the communication device body and beneath the display screen.

28. The communication device of claim 27, wherein the gaming pad is hidden when the communication device is in the first mode of operation and the gaming pad is visible when the communication device is in the second mode of operation.

29. A communication device comprising:
a communication device body in a first position adapted for a first mode of operation;
a display screen disposed in a generally parallel relationship with the device body in said first mode of operation;
pivoting means disposed between said display screen and said device body for permitting said display screen to pivot into a second position for a second mode of operation; and
wherein in the first mode of operation, the communication device is operable by one hand of a user and in the second mode of operation, the communication device is operable by two hands of a user.

30. The communication device of claim 29, wherein the first mode is a communication mode.

31. The communication device of claim 29, wherein the second mode is a gaming mode.

32. The communication device of claim 29, wherein the second mode is a messaging mode.

33. The communication device of claim 29, further comprising a gaming pad disposed on the communication device body and beneath the display screen.

34. The communication device of claim 33, wherein the gaming pad is hidden when the communication device is in the first mode of operation and the gaming pad is visible when the communication device is in the second mode of operation.
